(19) United States
(12) Patent Application Publication
(10) Pub. No.: US 2023/0399493 A1
(43) Pub. Date: Dec. 14, 2023

(54) FLAME-RETARDANT RESIN COMPOSITION, FLAME-RETARDANT RESIN MOLDED PRODUCT, FLAME-RETARDANT RESIN HOUSING, AND ELECTRONIC DEVICE

(71) Applicant: Konica Minolta, Inc., Tokyo (JP)

(72) Inventors: Kosuke NAKAMURA, Tokyo (JP); Tomoo SAKIMURA, Tokyo (JP); Shinichi HAMAGUCHI, Tokyo (JP)

(21) Appl. No.: 18/318,309

(22) Filed: May 16, 2023

(30) Foreign Application Priority Data
Jun. 8, 2022 (JP) 2022-092627

(51) Int. Cl. C08L 1/02

(52) U.S. Cl. CPC C08L 1/02; C08L 2201/02; C08L 2203/206; C08L 2205/03

(57) ABSTRACT

The subject of this invention is to provide a flame-retardant resin composition with improved flame-retardancy and impact resistance, a flame-retardant resin molded product, a flame-retardant resin housing, and an electronic device. The flame-retardant resin composition of the present invention contains at least a thermoplastic resin and a polysaccharide, the polysaccharide being an acidic polysaccharide, and the flame-retardant resin composition further contains a compatibilizer.

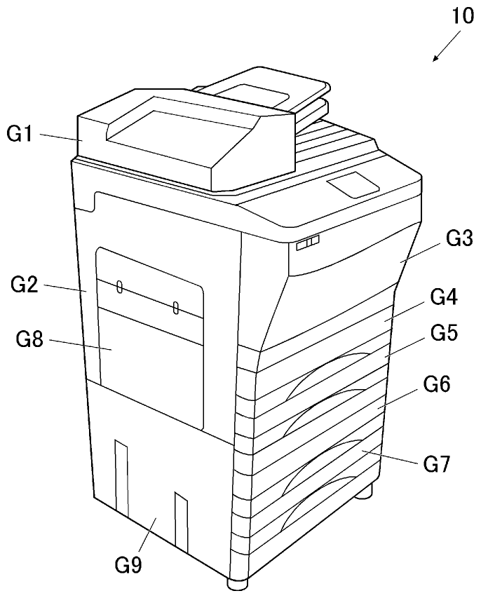

### REFERENCE TO RELATED APPLICATIONS

The entire disclosure of Japanese Patent Application No. 2022-092627, filed on Jun. 8, 2022, including description, claims, drawings and abstract is incorporated herein by reference in its entirety.

### TECHNICAL FIELD

The present invention relates to a flame-retardant resin composition, a flame-retardant resin molded product, a flame-retardant resin housing, and an electronic device. More particularly, the present invention relates to a flame-retardant resin composition with improved flame-retardancy and impact resistance.

### DESCRIPTION OF THE RELATED ART

In recent years, there has been a growing need to reduce the environmental burden, and biomass resins, which substitute petroleum raw materials for biomass raw materials, have been attracting attention. Compared to petroleum-based resins (resins synthesized from petroleum), the use of biomass resins is expected to reduce energy consumption during manufacturing and carbon dioxide emissions during final incineration and disposal.

Biomass resins are being considered for use in electrical and electronic equipment, the use of which has been increasing in recent years. However, since electrical and electronic equipment has a potential risk of ignition due to short-circuit or deterioration of circuits, biomass resins must be flame-retardant from the viewpoint of safety, such as fire prevention, before they may be used as materials for components and housings of electrical and electronic equipment.

For example, phosphorus flame-retardants may be cited as flame-retardants used to provide flame-retardancy. However, since most phosphorus flame-retardants are made from fossil resources, adding an appropriate amount to provide sufficient flame-retardancy will greatly reduce the biomass content of the overall resin. Therefore, from the viewpoint of balancing the biomass content of the entire resin and flame-retardancy, the use of natural polysaccharides as flame-retardants has been attracting attention.

Polysaccharides are compounds whose basic backbone is a cyclic structure containing a large amount of hydroxy groups, and they generate water vapor as a result of dehydration and condensation upon heating during combustion. In addition, the carbonization of polysaccharides after dehydration results in the formation of a film (hereinafter referred to as “char” or “carbonized layer”) that has an insulating effect, resulting in a high flame-retardant effect.

However, in the method using polysaccharides as a flame-retardant, heat is generated when polysaccharides are added to the resin and mixed, resulting in dehydration and condensation of the polysaccharides, which reduces the flame-retardant properties and does not provide the desired flame-retardancy.

In response to such problems, Patent Document 1 (JP-A 2005-162870) discloses a technology for resin compositions containing an aliphatic polyester resin, a polysaccharide, and a hydrolysis inhibitor that inhibits hydrolysis of the aliphatic polyester resin. In this technology, an aliphatic polyester resin and a polysaccharide are used together, and by adding a hydrolysis inhibitor, high heat resistance and mechanical strength are achieved in the resin composition after molding. However, the demand for flame-retardancy continues to increase, and further improvements are needed.

### SUMMARY OF THE INVENTION

The present invention was made in view of the above problems and circumstances, and its solution is to provide a flame-retardant resin composition with improved flame-retardancy and impact resistance, a flame-retardant resin molded product, a flame-retardant resin housing, and an electronic device.

In order to solve the above problem, the inventor investigated the cause of the above problem, and as a result, the inventor discovered the following. In the flame-retardant resin composition containing at least a thermoplastic resin and a polysaccharide, when the polysaccharide is an acidic polysaccharide, and the flame-retardant resin composition further contains a compatibilizer, the inventors have found that the flame-retardancy and impact resistance are improved, and have achieved the present invention. In other words, the above issues related to the present invention are solved by the following means.

A flame-retardant resin composition containing at least a thermoplastic resin and a polysaccharide; wherein the polysaccharide is an acidic polysaccharide; and the flame-retardant resin composition further contains a compatibilizer.

The above means of the present invention enables to provide a flame-retardant resin composition with improved flame-retardancy and impact resistance, a flame-retardant resin molded product, a flame-retardant resin housing, and an electronic device.

Although the expression mechanism or action mechanism of the effects of the present invention has not been clarified, it is speculated as follows.

One of the methods for imparting flame-retardancy to resins is to generate water vapor from inside the resin when the resin is ignited to lower the temperature of the resin and stop it from burning. Specifically, as mentioned above, it is thought that by including a polysaccharide in the resin, a dehydration-condensation reaction of the polysaccharide proceeds, generating water vapor and lowering the temperature. However, although the polysaccharides specifically mentioned in Patent Document 1 provide flame-retardancy, the effect is not sufficient, and further improvement is required.

The present inventor has examined the polysaccharide and found that the flame-retardancy is improved by using an acidic polysaccharide that has a portion of the polysaccharide molecule that functions as an acid. Although the mechanism of its expression or action is not clear, it is thought that the dehydration-condensation reaction is more accelerated because many of the acidic polysaccharides in question have acidic functional groups, which make it easier for protons (H⁺) to leave, and the distance between the protons and hydroxy groups in the polysaccharide is relatively close. The generation of water vapor may lower the temperature of the resin, and in addition, the polysaccharides after dehydration carbonize to form a carbonized layer, which is thought to improve flame-retardancy because the supply of oxygen may be cut off more.

On the other hand, acidic polysaccharides have many hydrophilic hydroxy groups and acidic functional groups (carboxy groups, sulfo groups) and are relatively incompatible with hydrophobic resins. Therefore, in resin compositions, interfaces between acidic polysaccharides and resins are easily formed and are easily destroyed at the interfaces by external impacts.

On the other hand, by further including a compatibilizer with high affinity for both an acidic polysaccharide and a resin in the resin composition, the acidic polysaccharide and the resin are compatibilized and the formation of an interface may be suppressed, which is thought to improve impact resistance.

In addition, in the resin composition, if there is even a portion where an acidic polysaccharide is relatively absent or nonexistent, the resin will burn from that portion. Therefore, it is necessary to uniformly disperse the acidic polysaccharide so that there is no portion where the acidic polysaccharide are relatively absent or nonexistent.

It is believed that the inclusion of the compatibilizer in the resin composition makes the acidic polysaccharide more compatible with the resin, thereby inhibiting aggregation of the acidic polysaccharide particles and improving their dispersibility. The improved dispersibility is thought to improve flame-retardancy because the acidic polysaccharide is dispersed uniformly in the resin composition, i.e., it is less likely that there will be areas where the acidic polysaccharide is absent.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein: the FIGURE shows a schematic perspective view of a large copying machine as an application example of the flame-retardant resin molded product of the present invention.

### DETAILED DESCRIPTION

Hereinafter, one or more embodiments of the present invention will be described with reference to the drawings. However, the scope of the invention is not limited to the disclosed embodiments.

The flame-retardant resin composition is characterized in that it contains at least a thermoplastic resin and a polysaccharide, wherein the polysaccharide is an acidic polysaccharide; and the flame-retardant resin composition further contains a compatibilizer. This feature is a technical feature common to or corresponding to the following embodiments.

From the viewpoint of expressing the effect of the present invention, it is preferred that the sugar backbone in the acidic polysaccharide has at least an acidic functional group, or a salt of an acidic functional group.

In terms of impact resistance, it is preferred that the salt of an acidic functional group is a divalent or more salt.

In terms of flame-retardancy and impact resistance, it is preferred that the total number of the acidic functional group and the salt of the acidic functional group per monosaccharide unit in the acidic polysaccharides is in the range of 0.20 to 1.40, and more preferably in the range of 0.60 to 1.20.

In terms of flame-retardancy and impact resistance, it is preferred that the content of the acidic polysaccharide to the total mass of the flame-retardant resin composition is in the range of 5.0 to 40.0 mass %.

In terms of flame-retardancy and impact resistance, it is preferred that the content of the compatibilizer to the total mass of the flame-retardant resin composition is in the range of 0.5 to 20.0 mass %.

As an embodiment of the present invention, it is preferred that the acidic functional group is a carboxy group or a sulfo group from the viewpoint of flame-retardancy.

As an embodiment of the present invention, it is preferred that the acidic polysaccharide contains at least one of alginic acid, alginate, carrageenan, pectin, xanthan gum or gellan gum from the viewpoint of being a natural acidic polysaccharide, and further, from the viewpoint of flame-retardancy and impact resistance, it is more preferred that the alginate is calcium alginate.

As an embodiment of the present invention, it is preferred that the compatibilizer is a copolymer having a structural unit derived from maleic acid from the viewpoint of flame-retardancy and impact resistance.

As an embodiment of the present invention, from the viewpoint of flame-retardancy and impact resistance, it a is preferable that the acid value of the copolymer having structural unit derived from maleic acid described above is in the range of 50 to 500 mg/KOH, and it is more preferable that the acid value is in the range of 100 to 500 mg/KOH.

As an embodiment of the present invention, it is preferred that the copolymer having a structural unit derived from maleic acid is a styrene/maleic anhydride copolymer from the viewpoint of flame-retardancy and impact resistance.

In terms of flame-retardancy and impact resistance, it is preferable that the softening point of the thermoplastic resin is 200° C. or less, and it is more preferable that the thermoplastic resin is a polystyrene-based resin.

The flame-retardant resin molded product of the present invention is formed using the flame-retardant resin composition of the present invention. The flame-retardant resin molded product is also included in the flame-retardant resin housing of the present invention and is furnished in the electronic device of the present invention.

The following is a detailed description of the invention, its components, and the form and manner of carrying out the invention. In this application, “to” is used in the sense of including the numerical values described before and after “to” as lower and upper limits.

1. Outline of Flame-Retardant Resin Composition

The flame-retardant resin composition of the present invention is characterized in that it contains at least a thermoplastic resin and a polysaccharide, wherein the polysaccharide is an acidic polysaccharide, and the flame-retardant resin composition further contains a compatibilizer. In the present invention, “flame-retardant resin composition” refers to a resin composition that has the following “flame-retardant properties”.

The term “flame-retardancy” is one of the properties of heat resistance and refers to the property of slow-burning but continuing to burn to some degree. Specifically, it means meeting the acceptance criteria in the UL94 standards established by Underwriters Laboratories (UL) of the United States of America, and in detail, meeting the acceptance criteria in UL94HB in the UL94 test (combustion test of plastic materials for equipment parts). In addition, it is preferable to meet the criteria for V-2 under UL94V, more preferable to meet the criteria for V-1, and even more preferable to meet the criteria for V-0.

The term “combustion” refers to an oxidation reaction involving the generation of light and heat, and combustion requires three elements: combustibles, an oxygen source, and an ignition source. In the case of resins (combustibles), once ignited (ignition source), the following phenomena (a) to (c) are repeated and combustion continues.

(a) The high temperature causes the resin (combustible material) to melt and decompose, generating a large amount of combustible gas.

(b) The high temperature environment causes combustible gases to radicalize and accelerate chemical reactions with oxygen in the air (oxygen source), generating substantial amounts of light and heat.

(c) The heat generated maintains the high temperature, so the decomposition of the resin continues.

Therefore, combustion may be stopped by either lowering the temperature, cutting off the oxygen supply, or removing flammable gases, and by designing the resin so that this phenomenon occurs when the fire is lit, the resin may be made flame-retardant.

Specifically, for example, water vapor is generated from inside the resin to lower the temperature (cooling by a large amount of heat absorption), a large amount of nonflammable gas is generated from the inside of the resin to lower the oxygen concentration, and oxygen supply is cut off. The surface of the resin is carbonized to form a barrier layer (corresponding to “char” or “carbonized layer” in the present invention) to cut off the supply of oxygen.

In the present invention, it is believed that the resin composition contains an acidic polysaccharide, which may cause the above phenomenon and provide flame-retardancy. It is also believed that the resin composition may improve flame-retardancy and impact resistance by further containing a compatibilizer.

The resin compositions may also be used as housings and components for electronic devices, by molding them into appropriate forms and shapes. In particular, when used as a housing, impact resistance is required in addition to flame-retardancy from the viewpoint of protecting electronic device housed in the housing from external shocks.

2. Composition of Flame-Retardant Resin Composition

The flame-retardant resin composition is characterized in that it contains at least a thermoplastic resin and a polysaccharide, wherein the polysaccharide is an acidic polysaccharide, and the flame-retardant resin composition further contains a compatibilizer.

The following is a description of each component of the flame-retardant resin composition. From the viewpoint of reducing environmental load, it is preferable that the materials used in the flame-retardant resin compositions are biomass materials, but materials other than biomass materials may also be used.

(1) Acidic Polysaccharide

The flame-retardant resin composition of the present invention contains an acidic polysaccharide. The flame-retardant resin composition of the present invention may be made flame-retardant by containing an acidic polysaccharide.

In the present invention, the term “acidic polysaccharide” refers to a polysaccharide having a portion in the molecule that functions as an acid.

To “function as an acid” means to function as a receptor (acceptor) for the electron pairs involved in binding (Lewis definition). Such function also includes functioning as a donor of protons (H⁺) (Brønsted definition).

In particular, from the viewpoint of flame-retardancy, an acidic polysaccharide preferably have an acidic functional group or a salt of an acidic functional group, and the acidic functional groups may be only one or two or more.

The term “polysaccharide” is a generic term that refers to a substance consisting of a number of monosaccharides dehydrated and condensed by glycosidic linkages. The type of monosaccharide that is the building block of a polysaccharide may be one type or more than one type.

The degree of polymerization of the polysaccharide is preferably in the range of 50 to 20,000, more preferably in the range of 200 to 1,500, and even more preferably in the range of 200 to 1,100.

The molecular weight of the polysaccharide is preferably in the range of 10,000 to 250,000 in weight average molecular weight based on polystyrene, as determined by gel permeation chromatography (GPC), and 20,000 to 80,000 is more preferred.

The term “monosaccharide” is a generic term for sugars that cannot be hydrolyzed further. It is a chain polyhydroxy compound with an aldehyde or ketone group, and usually exists in an intramolecular hemiacetalized cyclic form. The monosaccharide concerned is preferably a five-carbon sugar (pentose) or a six-carbon sugar (hexose), and hexose is more preferred. In the present invention, the term “sugar backbone” indicates a skeletal structure of monosaccharide.

For example, when only one type of monosaccharide (A) is used as a building block of a polysaccharide, the backbone structure of monosaccharide A is applicable to the sugar skeleton. In the present invention, the sugar backbone is characterized by having at least an acidic functional group or a salt of an acidic functional group in the skeletal structure of monosaccharide A.

When the monosaccharides that are the building blocks of the polysaccharide are of two types (A and B), the backbone structures of monosaccharides A and B are applicable to the sugar backbone. In this case, either the monosaccharide A or the monosaccharide B has at least an acidic functional group or a salt of an acidic functional group in the backbone structure.

Similarly, when there are three or more types of monosaccharides that constitute the constituent units of the polysaccharide, the backbone structure of each monosaccharide corresponds to the sugar skeleton, and any of the backbone structures of each monosaccharide has at least an acidic functional group or a salt of an acidic functional group. It should be noted that the polysaccharide does not necessarily have to have a structure with a repeating unit.

In the present invention, “the sugar backbone in the polysaccharide has at least one acidic functional group or a salt of an acidic functional group” means having at least one acidic functional group in the backbone structure of the monosaccharide in the polysaccharide, and the acidic functional group may also form a salt. Hereinafter, “acidic functional group or salt of acidic functional group” is also collectively referred to as an “acidic functional group”. Polysaccharides may have a basic functional group in addition to an acidic functional group. Furthermore, the basic functional group may form a salt.

In addition, all polysaccharides that have a portion in the molecule that functions as an acid fall under the category of acidic polysaccharides in the present invention. Therefore, even if the total number of basic functional group and the salt of the basic functional group in the molecule is greater than the total number of the acidic functional group and the salt of the acidic functional group, it still falls under acidic polysaccharides in the present invention.

In the present invention, from the viewpoint that biomass materials are preferably used, it is preferable to use natural polysaccharides as polysaccharides. However, the polysaccharide according to the present invention is not limited to those derived from natural origin.

It may also be a partially modified version of a natural polysaccharide. Specifically, an acidic functional group may be introduced into a polysaccharide having no acidic functional group to obtain the polysaccharide according to the present invention, or, if necessary, it may be a derivative.

Polysaccharide derivatives include compounds in which an atom in a moiety other than an acidic functional group is replaced by a different atom or substituent, e.g., a hydrogen atom in a polysaccharide is replaced by a substituent such as a halogen group (halogen atom) or a hydrocarbon group. Another example compounds are compounds obtained by binding to another compound or another molecule of the polysaccharide via a functional group other than an acidic functional group. Examples thereof include ester derivatives and ether derivatives obtained by reacting a hydroxyl group in a polysaccharide with a compound having a functional group reactive with the hydroxyl group, and crosslinked polysaccharides described later.

Examples of the acidic functional group include carboxy group (—COOH), sulfo group (—SO₃H), thiocarboxy group (—CSOH), sulfino group (—SO₂H), sulfeno group (—SOH), phospho group (—OP(═O)(OH)₂), phosphono group (—P(═O)(OH)₂), and borono group (—B(OH)₂). Among them, a carboxy group or a sulfo group is preferred from the viewpoint of flame-retardancy. The acidic functional group may be an acidic functional group with a sulfo group, for example, an acidic functional group (—O—SO₃H) in which a sulfo group is bonded to an oxygen atom.

Examples of the salt of an acidic functional group include salts with alkali metals such as Li, Na, and K, salts with alkaline earth metals such as Mg, Ca, Sr, and Ba, and alkylammonium (represented by “R₄N⁺—” where R is independently a hydrogen atom or an alkyl group with a carbon number in the range 1 to 3. However, at least one of the four R's is an alkyl group.)

Among the salts, salts with cations of divalent or higher are preferred. The salt with a cation of divalent or higher forms an intra- or intermolecular crosslinked structure, resulting in a rigid structure. As a result, heat resistance is dramatically improved and deformation of the resin composition during melt-kneading and molding may be prevented, resulting in excellent impact resistance and appearance.

From the viewpoint of superior flame-retardancy, the total number of the acidic functional group and the salt of the acidic functional group per monosaccharide unit in acidic polysaccharide (hereinafter simply referred to as “number of acidic functional groups”) is preferably in the range of 0.20 to 1.50. More preferably it is in the range of 0.60 to 1.20, and further preferably it is in the range of 0.60 to 1.00.

When the number of acidic functional groups is 0.20 or more, dehydration-condensation reaction may easily occur and flame-retardancy may be improved. Also, when the number of acidic functional groups is 1.50 or less, the decrease in dispersibility of acidic polysaccharides in the resin composition may be suppressed more, so that char may be formed uniformly on the surface of the resin composition, and flame-retardancy may be improved. One type of acidic polysaccharide may be used alone, or two or more types may be used in combination.

When two or more acidic polysaccharides are used in combination, the number of acidic functional groups of the entire acidic polysaccharide is preferably within the above range, but the number of acidic functional groups of the individual acidic polysaccharides to be combined is not necessarily within the above range. Individual acidic polysaccharides may be selected so that the total number of the acidic functional group in the combined acidic polysaccharides is within the above range.

In other words, when the acidic polysaccharide is a combination of two or more acidic polysaccharides, the individual acidic polysaccharides to be combined need not necessarily have acidic functional group numbers in the range of 0.20 to 1.50. The individual acidic polysaccharides should be selected so that the number of acidic functional groups is in the range of 0.20 to 1.50 in the overall acidic polysaccharide obtained in combination.

The number of acidic functional groups may be adjusted by introducing or separating acidic functional groups or salts of acidic functional groups (hereinafter collectively referred to as “acidic functional groups”) as appropriate.

It is preferable that the acidic polysaccharide is a naturally occurring acidic polysaccharide from the viewpoint of reducing environmental load. The naturally occurring polysaccharide may be adjusted to a suitable number of acidic functional groups by introducing or separating acidic functional groups as appropriate.

Monosaccharides with an acidic functional group, specifically those with a carboxy group, include uronic acids such as glucuronic acid, azuronic acid, mannuronic acid, and calacturonic acid. Monosaccharides having a sulfooxy group include galactose-3-sulfate.

Monosaccharides having both acidic and basic functional groups include muramic acid, N-acetylglucosamine-4-sulfate, N-acetylgalactosamine-4-sulfuric acid, neuraminic acid, and N-acetylneuraminic acid. Monosaccharides with a salt of acidic functional group include these salts.

When there are two or more types of monosaccharides that are the building blocks of polysaccharides, at least one type falls under the above monosaccharides, but there are no restrictions on the other monosaccharides, which may or may not fall under the above monosaccharides.

Other monosaccharides that do not fall under the above monosaccharides include ribose, arabinose, xylose, liquisose, xylulose, ribulose, deoxyribose, glucose, mannose, galactose, fructose, sorbose, tagatose, fucose, fuculose, and rhamnose.

Other monosaccharides may also have a basic functional group. Monosaccharides with a basic functional group include, for example, glucosamine, galactosamine, mannosamine, and their derivatives, and monosaccharides with a salt of a basic functional group include these salts.

The derivatives include N-substituted compounds or salts with inorganic salts such as sulfuric acid and organic acids such as acetic acid. Among them, N-substituted products with an organic acid are preferred, and N-acyl-substituted products are more preferred.

N-acyl substituents include, for example, N-formyl substituents, N-acetyl substituents, N-propionyl substituents, N-butyryl substituents, N N-isobutyryl substituent, N-valeryl substituent, N-isovaleryl substituent, and N-pivaloyl substituent. Among them, N-acetyl substituents are preferred, and N-acetyl substituents include, for example, N-acetylglucosamine, N-acetylgalactosamine, N N-acetylglucosamine, N-acetylgalactosamine, and N-acetylmannosamine.

Examples of the acidic polysaccharide composed of the above monosaccharides include pectin, alginic acid, propylene glycol alginate, carboxymethylcellulose, xanthan gum, gum arabic, karaya gum, psyllium, xylan, arabic acid, tragacanthic acid, khava gum, and flaxseed acid, cerulonic acid, licheninuronic acid, gellan gum, rhamzan gum, welan gum, carrageenan, glycosaminoglycans (e.g., hyaluronic acid, chondroitin-4-sulfate, chondroitin-6-sulfate, dermatan sulfate, keratin sulfate, and heparin) and salts thereof.

Among them, alginic acid, alginate, carrageenan, pectin, xanthan gum or gellan gum are preferred from the viewpoint of being natural acidic polysaccharides, and calcium alginate is more preferred from the viewpoint of improving flame-retardancy and impact resistance.

The number of acidic functional groups per monosaccharide unit in acidic polysaccharides may be calculated from the molecular structural formula or measured and calculated by the neutralization titration method. The following is a description of the molecular structure formulas for alginic acid and carrageenan and the method for calculating the number of acidic functional groups from the molecular structure formulas.

For example, the molecular structure of alginic acid is shown in Formula (A) below. As shown in Formula (A), the acidic functional group possessed by alginic acid is a carboxy group (—COOH). Based on the molecular structure in Formula (A), the number of acidic functional group of alginic acid may be set to 1.00.

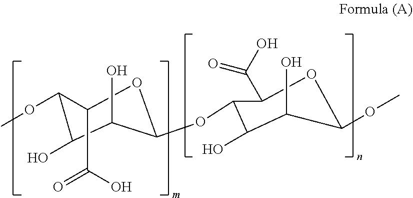

For example, there are three types of carrageenan: κ-carrageenan whose molecular structure is represented by the following Formula (C1), ι-carrageenan whose molecular structure is represented by the following Formula (C2), and λ-carrageenan whose molecular structure is represented by the following Formula (C3). As shown in Formulas (C1) to (C3), the acidic functional group possessed by carrageenan is a sulfo group, more specifically, an acidic functional group (—O—SO₃H) in which a sulfo group is attached to an oxygen atom. In Formulas (C1) to (C3), the acidic functional group is described in its ionized state (—OSO₃⁻).

The number of acidic functional groups of κ-carrageenan from the molecular structure in Formula (C1) is 0.50, and the number of acidic functional groups of ι-carrageenan from the molecular structure in Formula (C2) is 1.00. In formula (C3), typically R is H (30%) or SO₃⁻ (70%), and the number of acidic functional groups of λ-carrageenan from the molecular structure in Formula (C3) is 1.35.

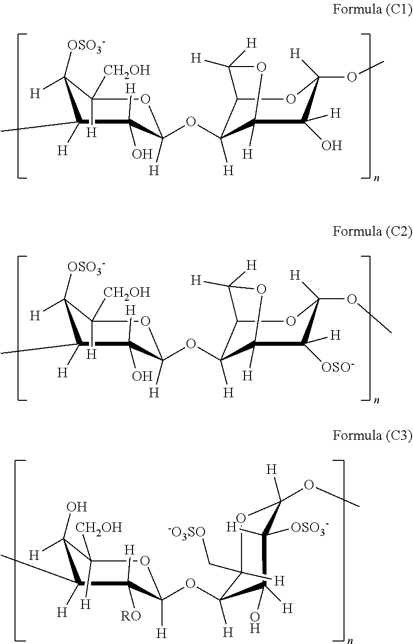

When the acidic polysaccharide is a combination of two or more acidic polysaccharides, the number of acidic functional groups may be determined from the number of acidic functional groups per monosaccharide unit and mole number ratio in each acidic polysaccharide using the following Equations (1) and (2).

Number of acidic functional groups=A₁×R₁+A₂×R₂+A₃×R₃+ . . . Equation (1):

Rₙ=Bₙ/(B₁+B₂+B₃+ . . . ) Equation (2):

Each symbol indicates as follows.
Aₙ: Number of acidic functional groups per monosaccharide unit in each acidic polysaccharide
Bₙ: Moles per unit of monosaccharide in each acidic polysaccharide (calculated by dividing the mass of each acidic polysaccharide by the average molecular weight of the monosaccharide)
Rₙ: Molar ratio per monosaccharide unit in each acidic polysaccharide

The number of acidic functional groups may also be determined by the following method.

To determine the number of acidic functional groups in the acidic polysaccharide contained in the flame-retardant resin composition, first extract the acidic polysaccharide from the flame-retardant resin composition by an appropriate method. The molecular structure of the extracted acidic polysaccharide is identified by thermogravimetric analysis, infrared spectroscopy (IR), or other methods.

[Method for Determining the Number of Acidic Functional Groups]

The number of acidic functional groups per monosaccharide unit in the acidic polysaccharide may be measured, for example, by the neutralization titration method. In the neutralization titration method, about 1 g of the extracted acidic polysaccharide is weighed and made into a slurry, which is then treated with a strongly acidic ion exchange resin. Then, 0.1 mol/L sodium hydroxide solution is added and the change in pH is observed to obtain a titration curve. The number of moles of sodium hydroxide required from the start of titration to the inflection point of the titration curve is equal to the number of moles of acid in the acidic polysaccharide used for titration. The number of acidic functional groups per monosaccharide unit may be calculated from the number of moles of acid obtained and the molecular structure.

In carboxymethyl cellulose, the number of acidic functional groups may be calculated by measuring the degree of substitution of carboxymethyl groups. Carboxymethyl cellulose is an acidic polysaccharide made by introducing carboxymethyl groups into cellulose. The number of acidic functional groups in carboxymethyl cellulose may be adjusted within a suitable range by adjusting the manufacturing conditions.

Carboxymethyl cellulose may be produced by any of the known production methods. Specifically, carboxymethyl cellulose may be produced by the method described in JP-A 2000-34301, which contains the process of reacting cellulose and alkali within a temperature range of 20 to 50° C. to produce alkali cellulose and the process of reacting alkali cellulose and monochloroacetic acid to produce carboxymethyl cellulose.

Carboxymethyl cellulose may also be produced by another method, for example, by mixing cellulose with an alkaline agent and monohaloacetic acid or its salt, followed by heating to react in the range of 40 to 90° C., according to the method described in JP-A 2012-12553.

In either method, the number of acidic functional groups in the resulting carboxymethyl cellulose may be adjusted by adjusting the amount of monochloroacetic acid or monohaloacetic acid added to the cellulose.

The structural formula of carboxymethyl cellulose may be expressed, for example, by the following Formula (CMC). In Formula (CMC), R represents H or CH₂COOH, respectively, independently. For example, by adjusting 0.2 to 1.5 of R in Formula (CMC) to be CHCOOH when averaged in the molecule, carboxymethyl cellulose having more excellent flame-retardancy may be obtained.

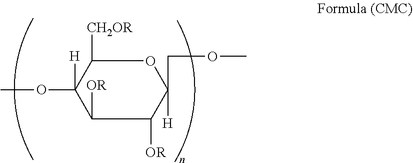

In addition to carboxymethyl cellulose, carboxyalkyl cellulose (e.g., with 2 to 3 carbon atoms), sulfoethyl cellulose, hydroxypropyl methyl cellulose acetate succinate are examples of acidic polysaccharides with acidic functional groups introduced into cellulose. In the present invention, polysaccharides other than cellulose that do not have acidic functional groups, such as acidic polysaccharides in which acidic functional groups are introduced into starch, agarose, guar gum may also be used.

[Method for Determining the Degree of Substitution of Carboxymethyl Groups]

In carboxymethyl cellulose, the number of acidic functional groups may be calculated by measuring the degree of substitution of carboxymethyl groups. The method is shown below. For other acidic polysaccharides, the number of acidic functional groups may also be calculated by referring to the following method.

The degree of substitution of the carboxymethyl group may be calculated by measuring the amount of base, such as sodium hydroxide, required to neutralize the carboxymethyl cellulose in the sample. If the carboxymethyl ether group is in a salt form, it should be converted to carboxymethyl cellulose in advance before measurement.

(Conversion to Carboxymethyl Cellulose)

Weigh accurately about 2.0 g of the sample and place it in a 300-mL stoppered Erlenmeyer flask. Add 100 mL of methanol nitrate (liquid of 1000 mL of methanol plus 100 mL of special grade of concentrated nitric acid), and shake at room temperature for 3 hours to convert the carboxymethyl cellulose salt to carboxymethyl cellulose.

(Determination of the Degree of Substitution of Carboxymethyl Cellulose)

Weigh accurately about 1.5 g of the dried carboxymethyl cellulose, place it in a 300-mL co-stoppered Erlenmeyer flask, and wet the carboxymethyl cellulose with 15 mL of 80% methanol. Then, add 100 mL of 0.1 N sodium hydroxide (NaOH) solution, shake it at room temperature for 3 hours, and reverse titrate the excess NaOH with 0.1 N sulfuric acid (H₂SO₄) using phenolphthalein as indicator.

The degree of substitution of carboxymethyl cellulose is calculated using the following Equations (i) and (ii).

A=(100×f₁−a×f₂)/mass of sample (g) Equation (i):

Degree of substitution=(162×A)/(10000-58×A) Equation (ii):

Each symbol and numerical value are as follows
A: Amount (mL) of 0.1 N sodium hydroxide solution required to neutralize 1 g of sample (absolutely dried carboxymethyl cellulose)
a: Titration volume (mL) of 0.1 N sulfuric acid
f₁: Factor of 0.1 N sodium hydroxide solution
f₂: Factor of 0.1 N sulfuric acid
100: Used amount (mL) of 0.1 N sodium hydroxide solution
162: Molecular weight of anhydrous glucose (C6H1005)
58: Molecular weight difference between CH₂COOH (molecular weight 59) and H (molecular weight 1)

In addition, cross-linked polysaccharides as derivatives of the above acidic polysaccharides may be used as acidic polysaccharides.

In the present invention, “cross-linked polysaccharide” refers to a compound having a structure in which the hydroxy groups in the sugar chain of two or more polysaccharide molecules are cross-linked. Cross-linked polysaccharides are obtained, for example, by cross-linking hydroxy groups between at least different molecules of polysaccharides using a cross-linking agent. As long as the cross-linking is between different molecules, it may include a structure in which two hydroxy groups are joined via a cross-linking agent in the same molecule. The type of polysaccharide molecules to be cross-linked may be the same or different.

Cross-linked polysaccharides used in the present invention are cross-linked acidic polysaccharides, and the acidic polysaccharides mentioned above may be used without restriction as the acidic polysaccharides constituting the cross-linked polysaccharides. The acidic polysaccharides used in the production (synthesis) of cross-linked polysaccharides are preferably at least one of the following: alginic acid, alginate, carrageenan, pectin, xanthan gum, or gellan gum. One of these may be used alone or in combination with two or more.

Cross-linking agents used in obtaining cross-linked polysaccharides from acidic polysaccharides include compounds having two or more functional groups that are reactive with hydroxy groups. The functional groups include, for example, an epoxy group, a chloro group, a silyl group, an isocyanate group, and an acid anhydride. Epichlorohydrin, hexamethylene diisocyanate, and tetraethyl silicate are examples of the cross-linking agent. Among them, epichlorohydrin is preferred.

Cross-linking of acidic polysaccharides with epichlorohydrin may be performed, for example, by the reactions shown in Formula (I-1) and Formula (I-2) below. In each formula, an asterisk “*” indicates the bonding moiety with the sugar backbone of the acidic polysaccharide.

Formula (I-1) takes place under alkaline conditions, where the epoxy ring of epichlorohydrin opens and reacts with the OH group of an acidic polysaccharide molecule to give intermediate (P). Furthermore, according to Formula (I-2), the terminal chloro group derived from epichlorohydrin in intermediate (P) reacts with the OH group of another acidic polysaccharide molecule, and the two acidic polysaccharide molecules are connected by a linking group (—CH₂—CH(OH)—CH₂—) to form a cross-link.

In the foregoing, the reactions shown in Formula (I-1) and Formula (I-2) were described as intermolecular reactions, but the reactions shown in Formula (I-1) and Formula (I-2) may take place in parallel and within a single molecule. In addition, a molecular end (—CH₂—CH(OH)—CH₂—Cl) similar to that of intermediate (P) may remain in the finally obtained product.

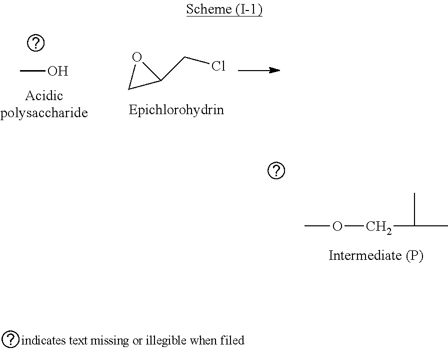

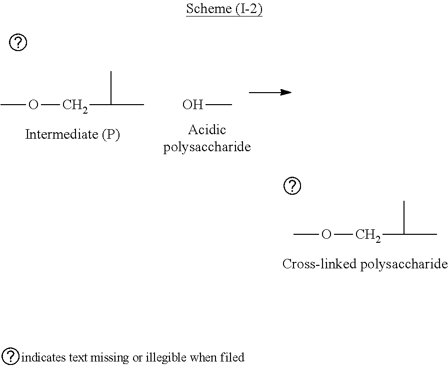

The degree of cross-linking in the cross-linked polysaccharide may be adjusted by the amount of cross-linking agent added to the acidic polysaccharide. The degree of cross-linking in the cross-linked polysaccharide should be such that the weight average molecular weight of the resulting cross-linked polysaccharide is within the preferred range of weight average molecular weight of the acidic polysaccharides mentioned above.

The number of acidic functional groups of the resulting cross-linked polysaccharide is theoretically the same as that of the acidic polysaccharide used as raw material. However, the acidic functional groups may react during production (synthesis), and the number of acidic functional groups of the resulting crosslinked polysaccharide is usually smaller than that of the acidic polysaccharide used as the raw material. Therefore, when cross-linked polysaccharides are synthesized and used in the present invention, the number of acidic functional groups of the resulting cross-linked polysaccharides should be measured and calculated by the neutralization titration method.

Commercial products of acidic polysaccharides are, for example, Kimica Acid SA (alginic acid, made by Kimica Co.), Snow Algin SAW-80 (calcium alginate, made by Kimica), Kimica Algin I-3G (sodium alginate, made by Kimica), Carrageenan WG-108 (carrageenan, made by Sansei Co.), Pectin, from citrus fruits (pectin, made by FUJIFILM Wako Pure Chemicals), Xanthan gum (xanthan gum, made by Tokyo Kasei Kogyo), Gellan gum (gellan gum, made by FUJIFILM Wako Pure Chemicals), Aqualon (registered trademark) CMC (carboxymethyl cellulose, made by ASHland).

From the viewpoint of flame-retardancy and impact resistance, it is preferable that the content of acidic polysaccharide is in the range of 5 to 40 mass % relative to the total mass of the flame-retardant resin composition, and more preferably, it is in the range of 20 to 30 mass %.

(2) Compatibilizer

The flame-retardant resin composition of the present invention contains a compatibilizer. The flame-retardant resin composition of the present invention may further improve flame-retardancy and impact resistance by containing a compatibilizer.

In the present invention, the term “compatibilizer” refers to a compound having a function of compatibilizing a thermoplastic resin and an acidic polysaccharide that do not have miscibility, affinity or compatibility with each other. Here, “to make compatible” means not only to give solubility to both the incompatible thermoplastic resin and the acidic polysaccharide, that is, not only to give miscibility. Rather, it refers to make a state in which compatibility, that is, affinity or compatibility, is exhibited for both the thermoplastic resin and the acidic polysaccharide.

In general, there are few combinations of polymer compounds that thermodynamically form a single phase, that is, that exhibit miscibility. Also in the present invention, there are very few combinations of a thermoplastic resin and an acidic polysaccharide that exhibit compatibility, and many combinations are considered to exhibit partial compatibility or incompatibility.

However, such incompatible combinations may be made compatible by using a compatibilizer. “Compatible state” refers to a state that forms multiple phases but is stable, that is, a state that exhibits affinity or compatibility. The compatibilization between the thermoplastic resin and the acidic polysaccharide according to the present invention will be described below.

Whether or not the acidic polysaccharide is compatible with the thermoplastic resin by including the compatibilizer may be judged comprehensively by observing, for example, the transparency in the flame-retardant resin molded product described below and the particle size of the particles observed when the molded product is observed as a thin film.

The structure of the compatibilizer is not limited, but it is preferred to have a highly reactive, compatible, or affinity moiety with the thermoplastic resin or acidic polysaccharide. It is also preferred to have a moiety with the same structure as the thermoplastic resin or acidic polysaccharide.

It is thought that the presence of such a structural moiety allows the acidic polysaccharide dispersed as particles in the flame-retardant resin composition to become finer and more uniform in diameter, thereby improving dispersion stability (compatibility).

The moieties with high reactivity, compatibility, or affinity for hydroxy groups and acidic functional groups in acidic polysaccharides include a carboxy group (—COOH), a carboxylic acid anhydride group (—COOCO—), a carboxylic acid ester group (—COOR), an epoxy group (—CR(—O—)—CRR′ or —CR(—O—)—CR—), an imino group (—NR— or ═NR), and an isocyanate group (—N═C═O). R and R′ each independently represent an organic group or a hydrogen atom.

Among them, a carboxylic anhydride group is preferable, and the carboxylic anhydride group includes a maleic anhydride group, a succinic anhydride group, a glutaric anhydride group, and a citric anhydride group, and particularly a succinic anhydride group is more preferable.

One or more compatibilizers may be used alone or in combination. The content of compatibilizer is preferably in the range of 0.5 to 20 mass %, more preferably in the range of 0.5 to 10 mass %, and even more preferably in the range of 0.5 to 5 mass %. Flame-retardancy and impact resistance may be improved by the content within the above range.

(2.1) Copolymer with Structural Unit Derived from Maleic Acid (Compound with Succinic Anhydride Group)

The compatibilizer according to the present invention is preferably a copolymer having a structural unit derived from maleic acid. In other words, it is preferred that the moiety with high reactivity, compatibility, or affinity with hydroxy groups or acidic functional groups is a succinic acid group or succinic anhydride group.

The term “copolymer having a structural unit derived from maleic acid” refers to a copolymer containing a structural unit derived from maleic acid in the main chain, that is, a copolymer containing a maleic acid monomer as a monomer component. It may be a polymer or a copolymer containing a structural unit derived from maleic acid in a side chain, that is, a copolymer modified with maleic acid. Alternatively, it may be a copolymer containing a structural unit derived from maleic acid at its terminal. The two carboxylic acids derived from maleic acid may be either dehydration-condensed or dehydration-condensed anhydrides.

The reaction for synthesizing a copolymer containing a maleic acid monomer as a monomer component or a copolymer modified with maleic acid is an addition reaction at the double bond of maleic acid, and finally, succinic acid or succinic anhydride groups are produced.

In the present invention, the two carboxylic acids derived from maleic acid are more preferably dehydration-condensed anhydrides, and the compatibilizer is more preferably a compound having a succinic anhydride group.

Formulas (1) and (2) below show the chemical structural formulas of structural units derived from maleic acid. That is, Formula (1) below represents succinic acid group, and Formula (2) represents succinic anhydride group. In addition, an asterisk “*” in the formula represents a bond or a hydrogen atom.

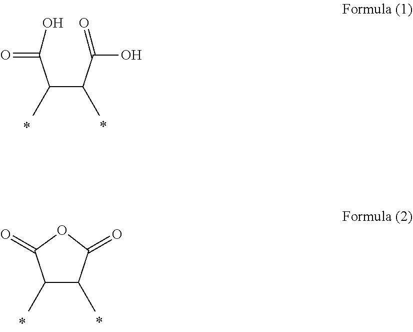

As described in detail below, since the thermoplastic resin of the present invention is preferably a polymer containing styrene monomer as a monomer component (polystyrene resin), it is preferable that the compatibilizer also be a compound having a structural unit derived from styrene.

Formulas (3) and (4) below show the chemical structure formula of styrene/maleic anhydride copolymers as copolymers having structural units derived from styrene and structural units derived from maleic acid.

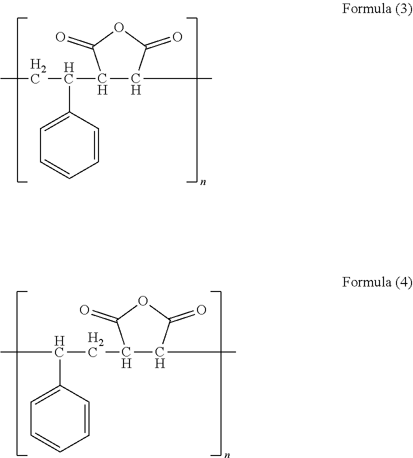

The degree of polymerization of styrene/maleic anhydride copolymers is preferably in the range of 20 to 10,000, more preferably in the range of 50 to 5,000, and even more preferably in the range of 50 to 1,500.

The molecular weight of styrene/maleic anhydride copolymers is preferably in the range of 2,000 to 1,000,000 in terms of weight average molecular weight based on polystyrene, as determined by gel permeation chromatography (GPC), and is more preferably in the range of 5,000 to 150,000.

The acid value of copolymers having structural units derived from maleic acid is preferably in the range of 50 to 500 mg/KOH, and more preferably in the range of 100 to 500 mg/KOH.

When the acid value is within the above range, that is, when the compatibilizer has a moderate amount of highly reactive, highly compatible, or highly compatible moieties with hydroxy groups or acidic functional groups, the acidic polysaccharide dispersed as particles in the flame-retardant resin composition is dispersed more uniformly and stably and is made compatible with them. The compatibilizer has a high degree of compatibility or high affinity.

Commercially available copolymers with a structural unit derived from maleic acid include RIKEAID (registered trademark) (maleic anhydride-modified polypropylene, made by RIKEN VITAMIN CORPORATION), ADMER (registered trademark) HE810 (maleic anhydride-modified polyethylene, made by Mitsui Chemicals Inc.), “Umex (registered trademark) 1010” (maleic anhydride-modified polypropylene, made by Sanyo Kasei Co., Ltd.), “OREVAC (registered trademark)” (maleic anhydride-modified polymer, made by Arkema Corporation), “Kraton (registered trademark) FG1901, FG1924” (maleic anhydride-modified SEBS polymer, made by Kraton Polymer Co., Ltd.), “Tuftec (registered trademark) M1911, 1913, 1941, 1943” (maleic anhydride-modified SEBS polymer, made by Asahi Kasei Corporation), and “XIRAN (registered trademark” (styrene/maleic anhydride copolymer, made by Polyscope Corporation).

(2.2) Compound with an Epoxy Group

In the compatibilizer according to the present invention, it is preferable that the portion having high reactivity, high compatibility, or high affinity with a hydroxyl group or an acidic functional group is an epoxy group. The compound having an epoxy group according to the present invention may be a copolymer containing an epoxy group in the main chain, a copolymer containing the epoxy group in the side chain, or a copolymer containing the epoxy group in the end. However, it is preferably a copolymer containing it in the side chain.

Commercially available compounds having an epoxy group include ARUFON (registered trademark) UG-4000 Series (acrylic polymer containing an epoxy group, made by Toagosei Co.), “Bondfast (registered trademark) 7B, 7M (epoxy group-containing polyolefin, made by Sumitomo Chemical Co., Ltd.), LOTADER (registered trademark) AX8840 (ethylene-acrylic ester-glycidyl methacrylate ternary copolymer, made by Arkema Corporation), MODIPER (registered trademark) A4100 (EGMA) (EGMA-g-PS: Ethylene-glycidyl methacrylate copolymer and graft polymer of polystyrene, made by Nichiyu Corporation).

(3) Thermoplastic Resin

The flame-retardant resin composition of the present invention contains a thermoplastic resin. The flame-retardant resin composition of the present invention may be molded into desired shapes using known melt-kneading methods and it is easy to handle due to the inclusion of a thermoplastic resin.

From the viewpoint of reducing environmental impact, it is preferable that the resin is a biomass resin, but the present invention is also applicable to resins other than biomass resins. It is also possible to use a combination of a biomass resin and a non-biomass resin.

The content of thermoplastic resin is preferably in the range of 30 to 95 mass %, more preferably in the range of 40 to 90 mass %, and even more preferably in the range of 50 to 80 mass % with respect to the total mass of the flame-retardant resin composition.

Although the type of thermoplastic resin is not restricted, it is preferable that the softening point of the thermoplastic resin is less than 200° C. from the viewpoint of being able to suppress the decomposition of acidic polysaccharide and having excellent strength and appearance in addition to flame-retardancy.

In the present invention, the term “softening point” refers to a temperature at which the material softens and begins to deform due to an increase in temperature. Specifically, it refers to the temperature measured by the method in accordance with “JIS K 2207 6.4 Softening Point Test Method (Ring Ball Method).

Thermoplastic resins include, for example, polystyrene resin, polycarbonate resin, aromatic polyester resin, polyphenylene sulfite resin, polyolefin resin, polyamideimide resin, polyetheretherketone resin, polyethersulfone resin, polyimide resin, polychlorinated polyvinyl chloride resin, polyamide resin, polyacetal resin, acrylic resin, polystyrene thermoplastic elastomer, polyolefin thermoplastic elastomer, polyurethane thermoplastic elastomer, 1,2-polybutadiene thermoplastic elastomer, ethylene-vinyl acetate copolymer thermoplastic elastomer, fluoroelastomer, and chlorinated polyethylene thermoplastic elastomer. One type of thermoplastic resin may be used alone or in combination with two or more types.

Thermoplastic biomass resins may also be used as thermoplastic resins. Examples of thermoplastic biomass resins include aliphatic polyester, polyamino acid, polyvinyl alcohol, polyalkylene glycol, and copolymer containing these resin. Thermoplastic biomass resins may also be combined with resins other than thermoplastic biomass resins as thermoplastic resins that have the advantages of both.

Polystyrene resins include, for example, polystyrene resin, syndiotactic polystyrene resin, acrylonitrile-styrene copolymer (AS resin), and acrylonitrile-butadiene-styrene copolymer (ABS resin).

Aromatic polyester resins include aromatic polyesters having a structure in which an aromatic dicarboxylic acid or its ester derivative component is linked to a diol component such as an aliphatic diol or alicyclic diol by an ester reaction. Specifically, polyethylene terephthalate, polypropylene terephthalate, polybutylene terephthalate, polyethylene naphthalate, polybutylene naphthalate, polyethylene-1,2-bis(phenoxy)ethane-4,4′-dicarboxylate, and copolymerized polyesters such as polyethylene isophthalate/terephthalate, polybutylene terephthalate/isophthalate, and polybutylene terephthalate/decanedicarboxylate.

Aliphatic polyesters include polyoxyacids, which are copolymers of oxyacids, and polycondensates of aliphatic diols and aliphatic dicarboxylic acids. Polyoxy acids include, for example, poly-L-lactic acid (PLLA), poly-D-lactic acid (PDLA), random copolymer of L-lactic acid and D-lactic acid, stereocomplexes of L-lactic acid and D-lactic acid, polycaprolactone, polyhydroxybutyric acid, and polyhydroxyvaleric acid. Polycondensates of aliphatic diols and aliphatic dicarboxylic acids include, for example, polyethylene succinate, polybutylene succinate (PBS), and polybutylene adipate.

From the viewpoint of strength and ease of handling, it is preferable that the thermoplastic resin is a resin having an aromatic ring. Examples of the resin with an aromatic ring include polystyrene resin, polycarbonate resin, and aromatic polyester resin, among which a polystyrene resin is preferred.

Commercially available thermoplastic resins include Panlite (registered trademark) (polycarbonate resin, made by Teijin Chemicals Limited), DURANEX (registered trademark) (polybutylene terephthalate, made by Polyplastics), CLAPET (registered trademark) (polyethylene terephthalate, made by Kuraray Inc.), ALAMIN (polyamide resin, made by Toray Industries, Inc.), LAYSIA (registered trademark) (polylactic acid resin, made by Mitsui Chemicals, Inc.), and TERRAMAC (registered trademark) (polylactic acid resin, made by Unitika, Ltd.). Commercial products of polystyrene resin are described below.

(3.1) Polystyrene Resin

The thermoplastic resin according to the present invention is preferably a polystyrene resin from the viewpoint of strength and ease of handling.

In the present invention, the term “polystyrene-based resin” refers to a polymeric material containing at least a styrene-based monomer as a monomer component. Here, “styrene monomer” refers to a monomer having a styrene skeleton in its structure.

The styrene-based monomer is not particularly limited as long as it is a monomer having a styrene backbone in its structure. Examples thereof include styrene, core alkyl-substituted styrene (o-methylstyrene, m-methylstyrene, p-methylstyrene, 2,4-dimethylstyrene, 4-ethylstyrene, and p-tert-butylstyrene), α-alkyl substituted styrene (α-methylstyrene). Among them, styrene is preferred.

The polystyrene resin may be a homopolymer of a styrene monomer or a copolymer of a styrene monomer and other monomer components. Monomer components that may be copolymerized with a styrene monomer include unsaturated carboxy acid ester monomers including alkyl methacrylate monomers such as methyl methacrylate, cyclohexyl methacrylate, methyl phenyl methacrylate, isopropyl methacrylate, and alkyl acrylate monomers such as methyl acrylate, ethyl acrylate, butyl acrylate, 2-ethylhexyl acrylate, and cyclohexyl acrylate; unsaturated carboxylic acid monomers such as methacrylic acid, acrylic acid, itaconic acid, maleic acid, fumaric acid, and cinnamic acid; unsaturated dicarboxylic anhydride monomers that are anhydrides such as maleic anhydride, itaconic acid, ethyl maleic acid, methyl itaconic acid, chloromaleic acid; unsaturated nitrile monomers such as acrylonitrile, methacrylonitrile; conjugated diene monomers such as 1,3-butadiene, 2 methyl-1,3-butadiene (isoprene), 2,3-dimethyl-1,3-butadiene, 1,3-pentadiene, and 1,3-hexadiene. Two or more of these monomers may be copolymerized. The ratio of such other monomer components to be copolymerized is preferably 50 mass % or less, more preferably 40 mass % or less, and still more preferably 30 mass % or less, based on the total mass of the styrene-based monomers.

As polystyrene resins, from the viewpoint of heat resistance, polystyrene resin, syndiotactic polystyrene resin, acrylonitrile-styrene copolymer (AS resin), acrylonitrile-butadiene-styrene copolymer (ABS resin), styrene-methacrylic acid copolymer, and styrene-maleic anhydride copolymer are preferred.

In acrylonitrile-butadiene-styrene copolymers (ABS resins), from the viewpoint of mechanical strength and heat resistance, it is preferred that the ratio of acrylonitrile copolymerization in the copolymer is in the range of 1 to 30 mass %, and it is further preferred that the ratio is in the range of 1 to 25 mass %.

In styrene-methacrylic acid copolymers, from the viewpoint of heat resistance, it is preferred that the ratio of copolymerization of methacrylic acid in the copolymer is 0.1 mass % or more of the total mass of the styrene-methacrylic acid copolymer. When transparency is to be imparted, it is preferable that the ratio is 50 mass % or less. When both heat resistance and transparency are desired, it is more preferable that the ratio is in the range of to 40 mass %, and it is even more preferable that the ratio is in the range of 0.1 to 30 mass %.

In styrene-maleic anhydride copolymers, from the viewpoint of heat resistance, it is preferred that the ratio of copolymerization of methacrylic acid in the copolymer is 0.1 mass % or more of the total mass of the styrene-maleic anhydride copolymer. When transparency is to be imparted, it is preferable that the ratio is 50 mass % or less. When both heat resistance and transparency are desired, it is more preferable that the ratio is in the range of 0.1 to 4 mass %, and it is even more preferable that the ratio is in the range of 0.1 to 30 mass %.

Commercially available polystyrene resins include CLEAREN (registered trademark) (SBC resin: styrene-butadiene copolymer, made by DENKI KAGAKU KOGYO KABUSHIKI KOGYO KAISHA), ASAFLEX (registered trademark) (SBC resin, made by Asahi Kasei Chemicals), STYROLUX (registered trademark) (SBC resin, made by BASF), PSJ (registered trademark)—polystyrene, made by Toray Industries, Inc. PSJ (registered trademark)—Polystyrene (polystyrene resin, made by PS Japan), TOYOLAC (registered trademark) (ABS resin, made by Toray Industries, Inc.). Also, commercially available products of mixed resins containing polystyrene resins include Multilon (registered trademark) (polycarbonate resin/ABS resin mixture, made by Teijin Limited).

It is preferred that the content of the polystyrene-based resin is 50 mass % or more, more preferably, 60 mass % or more, and still more preferably 80 mass % or more in relation to the total mass of the thermoplastic resin. In the flame-retardant resin composition of the present invention, it is particularly preferred that the thermoplastic resin is composed solely of polystyrene-based resin.

(4) Other Additives

The flame-retardant resin composition of the present invention may contain other additives according to the purpose and to the extent that the effect of the invention is not impaired.

Examples of the additive include antioxidants, fillers, and crystal nucleating agents. The content of additives is preferably in the range of 0 to 30 mass %, and more preferably in the range of 0 to 20 mass % with respect to the total mass of the flame-retardant resin composition.

3. Method for Manufacturing Flame-Retardant Resin Composition

The method of manufacturing the flame-retardant resin composition of the present invention is not particularly restricted, and the melt-kneading method is preferable, and any known melt-kneading method may be used. The following is a description of the method of producing the flame-retardant resin compositions of the present invention using the melt-kneading method.

The melt-kneading method includes, for example, pre-mixing a thermoplastic resin, an acidic polysaccharide, and a compatibilizer using various mixers such as tumblers or high-speed mixers known as Henschel mixers, followed by melt-kneading using kneading device such as a Banbury mixer, roll, plastograph, single screw extruder, twin screw extruder, or kneader. The following methods may be cited.

Among these, the use of an extruder is preferred from the viewpoint of production efficiency, and the use of a twin-screw extruder is more preferred. After the materials are melted and kneaded using an extruder and the kneaded material is extruded into strands, the kneaded material may be processed into pellets, flakes, or other shapes.

It is preferred that each material is thoroughly dried prior to pre-mixing the materials. The drying temperature is not particularly restricted, but it is preferably in the range of 60 to 120° C. The drying time is not particularly restricted, but it is preferably in the range of 2 to 6 hours. From the viewpoint of more progressive drying, drying under reduced pressure is preferred. The above drying may be performed after pre-mixing.

The temperature of melt-kneading is not particularly restricted, but it is preferably selected according to the type of thermoplastic resin used. Specifically, the temperature is preferably in the range of 150 to 280° C. Here, the temperature of melt-kneading corresponds to the cylinder temperature in a kneading device such as a twin-screw extruder, for example. The cylinder temperature refers to the temperature of the highest cylinder section when multiple temperature settings are made in the cylinder of the kneading device. The kneading pressure is not particularly limited, but it is preferably in the range of 1 to 20 MPa.

The discharge rate from the kneading device is not particularly limited, but from the viewpoint of adequate melt-kneading, it is preferred to be in the range of 10 to 100 kg/hr, and more preferably in the range of 20 to 70 kg/hr.

It is preferable that the kneaded material melted and kneaded by the kneading device in the above method is cooled after being extruded from the kneading device. The method of cooling treatment is not particularly limited, and includes, for example, immersing the kneaded material in water in the range of 0 to 60° C. for water cooling, cooling with gas in the range of to 40 to 60° C., and contacting it with metal in the range of −40 to 60° C.

The form and shape of the flame-retardant resin composition of the present invention is not particularly restricted and may be in solid form, such as powder, granules, tablets (tablets), pellets, flakes, fibers, or in liquid form.

4. Flame-Retardant Resin Molded Product

The flame-retardant resin molded product of the present invention is characterized by being formed using the aforementioned flame-retardant resin composition. The flame-retardant resin molded product of the present invention is formed using the aforementioned flame-retardant resin composition, which imparts flame-retardancy and impact resistance to the resin molded product.

The flame-retardant resin molded product of the present invention is obtained by melting and molding the aforementioned flame-retardant resin composition in various molding machines. The molding method may be selected according to the form and application of the molded product. Examples of the molding method include injection molding, extrusion molding, compression molding, blow molding, calender molding, and inflation molding. Secondary molding such as vacuum forming or pressure molding may be performed on the sheet or film-like molded product obtained by extrusion molding or calendaring molding.

Flame-retardant resin molded products are not restricted, and include, for example, components in the fields of home appliances and automobiles (electrical and electronic components, electrical components, exterior components, interior components), various packaging materials, household goods, office supplies, piping, and agricultural materials.

5. Flame-Retardant Resin Housing and Electronic Device

The flame-retardant resin housing of the present invention is characterized in that it contains the aforementioned flame-retardant resin molded product. The electronic device of the present invention is also characterized in that it is equipped with the aforementioned flame-retardant resin molded product. In other words, the aforementioned flame-retardant resin molded product may be used in electronic devices, either as a housing to accommodate the electronic device or as a component. In the present invention, the term “electronic device” refers to electrical products based on electronics technology.

The articles to be housed by the flame-retardant resin housing of the present invention are not particularly restricted, but it is preferable to house electronic device. The flame-retardant resin housing of the present invention may also be applied to other housings that are generally preferred to be manufactured with flame-retardant resin.

Electronic devices are not restricted, and includes, for example, computers, scanners, copying machines, printers, facsimile machines, office automation equipment such as multifunctional machines called MFPs (Multi Function Peripheral) that combine these functions, and digital printing systems for commercial printing.

The FIGURE shows a specific example of an electronic device of the present invention. The FIGURE is a schematic diagram of a large-size copying machine 10 using the flame-retardant resin molded product of the present invention as an exterior component. As shown in the FIGURE, the large-size copying machine 10 is externally encased with exterior components G1 to G9. The flame-retardant resin molded products of the present invention may be used for such exterior components.

### Examples

Hereinafter, the present invention will be specifically described with reference to Examples, but the present invention is not limited to these examples. In the examples, “part” or “%” is used to indicate “part by mass” or “mass %” unless otherwise noted. In the examples below, operations were performed at room temperature (25° C.) unless otherwise noted.

[Preparation of Resin Compositions 1 to 40]

The following thermoplastic resins, acidic polysaccharides, and compatibilizers were used as constituents of the resin compositions 1 to 40 in the examples.

(Thermoplastic Resin)

The following commercial products were used as thermoplastic resins. The softening point of the mixed resin was 200° C. or higher, and the softening points of the other resins were 200° C. or lower. The softening point was measured by a method in accordance with “JIS K 2207 6.4 Softening point test method (circular ball method).

1. Polystyrene Resin

Polystyrene resin (PS): “H9152” (product name, made by PS Japan) Acrylonitrile-butadiene-styrene copolymer (ABS): TOYOLAC (registered trademark) 700-314 (product name, made by Toray Industries, Inc.)

2. Other Thermoplastic Resins

Polylactic acid resin (PLA): Terramac (registered trademark) TE-8303 (product name, made by Unitika Ltd.)

Mixed resin (PC/ABS): Multilon (registered trademark) T-3750 (product name, made by Teijin Limited)

(Acidic Polysaccharides)

The following commercial products and those obtained in the synthetic examples were used as acidic polysaccharides. Cellulose (C1) was also used as a polysaccharide other than acidic polysaccharides.

A1: Calcium alginate (acidic functional group number 1.00), Snow Algin SAW-80 (product name, made by Kimica)

A2: Carrageenan (acidic functional group number 0.50), Carrageenan WG-108 (product name, made by Sansho Co., Ltd.)

A3: Xanthan gum (acidic functional group number 0.40), Xanthan gum (product name, made by Tokyo Kasei Kogyo Co., Ltd.)

A4: Sodium alginate (acidic functional group number 1.00), Kimica Algin I-3G (product name, made by Kimica)

A5: Carboxymethyl cellulose (acidic functional group number 1.40), Aqualon (registered trademark) CMC-7LF (product name, made by ASHland)

A10: Pectin (acidic functional group number 0.40), Pectin, derived from citrus fruits (product name, made by FUJIFILM Wako Pure Chemicals Co., Ltd.)

A11: Gellan gum (acidic functional group number 0.25), Gellan gum (product name, made by FUJIFILM Wako Pure Chemicals Co.)

A12: Alginic acid (acidic functional group number 1.00), Kimica Acid SA (product name, made by Kimica)

C1: Cellulose (acidic functional group number 0.00), Cellulose, powder, 38 μm pass-through (product name, made by FUJIFILM Wako Pure Chemicals Co., Ltd.)

(A6: Synthesis of Carboxymethyl Cellulose)

The following ingredients were placed in a 5 L flask and stirred at room temperature.

Isopropyl alcohol: 2,500 parts by mass

Water: 180 parts by mass

Powdered cellulose (cellulose, powder, 38 lam passage (made by FUJIFILM Wako Pure Chemicals Co., Ltd., Polysaccharide C1): 100 parts by mass

To this was added a solution dissolving the following ingredients, and the mixture was stirred at 35° C. for 1 hour.

Sodium hydroxide: 21.6 parts by mass

Water: 25 parts by mass

Then, a mixture of the following ingredients was added dropwise, and the mixture was stirred and reacted at 65° C. for 2 hours.

Monochloroacetic acid: 11.6 parts by mass

Isopropyl alcohol: 15 parts by mass

The resulting reaction solution was cooled to room temperature, removed, and the following components were added and stirred to neutralize excess sodium hydroxide.

70 Mass % methanol solution: 1,000 parts by mass

Acetic acid: 0.1 parts by mass

The following components were then added, and after stirring, the slurry was filtered, acetone washed, and dried to obtain 103 parts by mass of carboxymethyl cellulose as polysaccharide A6.

70 Mass % methanol aqueous solution: 3,000 parts by mass

The number of acidic functional groups in the resulting acidic polysaccharide A6 was checked using the aforementioned method of measuring the degree of substitution of carboxymethyl groups and found to be 0.20.

(A7: Synthesis of Carboxymethyl Cellulose)

The following ingredients were placed in a 5 L flask and stirred at room temperature.

Isopropyl alcohol: 2,500 parts by mass

Water: 180 parts by mass

Powdered cellulose (cellulose, powder, 38 μm passage (made by FUJIFILM Wako Pure Chemicals Co., Ltd.), Polysaccharide C1): 100 parts by mass

To this was added a solution dissolving the following ingredients, and the mixture was stirred at 35° C. for 1 hour.

Sodium hydroxide: 56.1 parts by mass

Water: 60 parts by mass

Then, a mixture of the following ingredients was added dropwise, and the mixture was stirred and reacted at 65° C. for 2 hours.

Monochloroacetic acid: 63.4 parts by mass

Isopropyl alcohol: 45 parts by mass

The resulting reaction solution was cooled to room temperature, removed, and the following components were added and stirred to neutralize excess sodium hydroxide.

Mass % methanol aqueous solution: 1,000 parts by mass

Acetic acid: 3.7 parts by mass

The following ingredients were then added, stirred, and the slurry was filtered, acetone washed, and dried to obtain 123 parts by mass of carboxymethyl cellulose as polysaccharide A7.

70 Mass % methanol aqueous solution: 3,000 parts by mass

The number of acidic functional groups of the obtained acidic polysaccharide A7 was checked using the aforementioned method of measuring the degree of substitution of carboxymethyl groups and found to be 0.61.

(A8: Synthesis of Carboxymethyl Cellulose)

The following ingredients were placed in a 5 L flask and stirred at room temperature.

Isopropyl alcohol: 2,500 parts by mass

Water: 180 parts by mass

Powdered cellulose (cellulose, powder, 38 μm passage (made by FUJIFILM Wako Pure Chemicals Co., Ltd.), polysaccharide C1): 100 parts by mass

To this was added a solution dissolving the following ingredients, and the mixture was stirred at 35° C. for 1 hour.

Sodium hydroxide: 160 parts by mass

Water: 150 parts by mass

Then, a mixture of the following ingredients was added dropwise, and the mixture was stirred and reacted at 65° C. for 2 hours.

Monochloroacetic acid: 180 parts by mass

Isopropyl alcohol: 130 parts by mass

The resulting reaction solution was cooled to room temperature, removed, and the following components were added and stirred to neutralize excess sodium hydroxide.

70 Mass % methanol aqueous solution: 1,000 parts by mass

Acetic acid: 8.2 parts by mass

The following components were then added, stirred, and the slurry was filtered, acetone washed, and dried to obtain 152 parts by mass of carboxymethyl cellulose as polysaccharide A8.

70 Mass % methanol aqueous solution: 3,000 parts by mass

The number of acidic functional groups in the obtained acidic polysaccharide A8 was checked using the aforementioned method of measuring the degree of substitution of carboxymethyl groups, and found to be 1.70.

(A9: Preparation of Barium Alginate)

One part by mass of sodium alginate (“Kimica Algin I-3G”, made by Kimica) was dissolved by adding it little by little to vigorously stirred water (100 parts by mass). The aqueous solution was then dropped into a 1% aqueous solution of barium chloride (100 parts by mass) that was stirred vigorously; after stirring for 20 minutes, the solution was filtered, washed with water, and washed with ethanol, then spread on a bat and dried at 50 to 60° C. until a constant volume was confirmed, yielding barium alginate. The acidic functional group number of the resulting acidic polysaccharide A9 was checked and found to be 1.00.

(A13: Synthesis of Carboxymethyl Cellulose)

The following ingredients were placed in a 5 L flask and stirred at room temperature.

Isopropyl alcohol: 2,500 parts by mass

Water: 180 parts by mass

Powdered cellulose (cellulose, powder, 38 lam passage (made by FUJIFILM Wako Pure Chemicals Co., Ltd.), polysaccharide C1): 100 parts by mass

To this was added a solution dissolving the following ingredients, and the mixture was stirred at 35° C. for 1 hour.

Sodium hydroxide: 10.8 parts by mass

Water: 25 parts by mass

Then, a mixture of the following components was added dropwise, and the mixture was stirred and reacted at 65° C. for 2 hours.

Monochloroacetic acid: 5.8 parts by mass

Isopropyl alcohol: 15 parts by mass

The resulting reaction solution was cooled to room temperature, removed, and the following components were added and stirred to neutralize excess sodium hydroxide.

70 Mass % methanol aqueous solution: 1,000 parts by mass

Acetic acid: 0.1 parts by mass

The following components were then added, stirred, and the slurry was filtered, acetone washed, and dried to obtain 101 parts by mass of carboxymethyl cellulose as polysaccharide A13.

70 Mass % methanol aqueous solution: 3,000 parts by mass

The number of acidic functional groups in the resulting acidic polysaccharide A13 was checked using the aforementioned method of measuring the degree of substitution of carboxymethyl groups and found to be 0.10.

(A14: Synthesis of Carboxymethyl Cellulose)

The following ingredients were placed in a 5 L flask and stirred at room temperature.

Isopropyl alcohol: 2,500 parts by mass

Water: 180 parts by mass

Powdered cellulose (cellulose, powder, 38 lam passage (made by FUJIFILM Wako Pure Chemicals Co., Ltd.), polysaccharide C1): 100 parts by mass

To this was added a solution dissolving the following ingredients, and the mixture was stirred at 35° C. for 1 hour.

Sodium hydroxide: 110 parts by mass

Water: 110 parts by mass

Then, a mixture of the following ingredients was added dropwise, and the mixture was stirred and reacted at 65° C. for 2 hours.

Monochloroacetic acid: 120 parts by mass

Isopropyl alcohol: 90 parts by mass

The resulting reaction solution was cooled to room temperature, removed, and the following components were added and stirred to neutralize excess sodium hydroxide.

70 Mass % methanol aqueous solution: 1,000 parts by mass

Acetic acid: 6 parts by mass

The following components were then added, stirred, and the slurry was filtered, acetone washed, and dried to obtain 138 parts by mass of carboxymethyl cellulose as polysaccharide A14.

70 Mass % methanol aqueous solution: 3,000 parts by mass

The number of acidic functional groups in the resulting acidic polysaccharide A14 was checked using the aforementioned method of measuring the degree of substitution of carboxymethyl groups and found to be 1.20.

(Compatibilizer)

The following commercial products were used as a compatibilizer.

MA-g-PP1: Maleic anhydride modified polypropylene (acid value: 23), “RIKEAID (registered trademark) MG 250P (product name, made by RIKEN VITAMIN CORPORATION)

MA-g-PP2: Maleic anhydride modified polypropylene (acid value: 52), UMEX 1010 (registered trademark) (product name, made by Sanyo Chemical Co., Ltd.)

MA-g-SEBS1: Maleic anhydride modified SEBS polymer (acid value: 2), TUFTEC M1911 (registered trademark) (product name, made by Asahi Kasei Corporation)

MA-g-SEBS2: Maleic anhydride modified SEBS polymer (acid value: 10), TUFTEC (registered trademark) M1941 (product name, made by Asahi Kasei Corporation)

EGMA-g-PS: Ethylene-glycidyl methacrylate copolymer and polystyrene graft polymer, MODIPER (registered trademark) A4100 (product name, made by Nichiyu Co., Ltd.)

SMA1: Styrene/maleic anhydride copolymer 1 (acid value: 285), XIRAN (registered trademark) 3000 (product name, made by Polyscope Corporation)

SMA2: Styrene/maleic anhydride copolymer 2 (acid value: 120), XIRAN (registered trademark) 9000 (product name, made by Polyscope Corporation)

SMA3: Styrene/maleic anhydride copolymer 3 (acid value 475), XIRAN (registered trademark) 1000 (product name, made by Polyscope Corporation)

(Preparation of Resin Compositions 1 to 40)

As pre-drying before kneading, the thermoplastic resin and polysaccharides were dried at 80° C. for 4 hours each. Then, they were weighed and dry-blended in the component ratios (mass %) shown in Table I or Table II. The dry-blended mixture was then fed at a rate of 10 kg per hour through the feed port (hopper) of a twin-screw extruder “KTX-30” (made by Kobe Steel, Ltd.), and melt-kneaded at a cylinder temperature of 200° C. (240° C. only for resin composition 37), and at a screw speed of 200 rpm, melt-kneading was performed. After kneading, the molten resin was cooled in a water bath at 30° C. and pelletized in a pelletizer to obtain resin compositions 1 to 40.

<<Evaluation>>

(Evaluation 1: Impact Resistance)

The obtained pellets of resin compositions 1 to 40 were dried at 80° C. for 4 hours, and then molded at a cylinder temperature of 200° C. (240° C. only for resin composition 37) and a mold temperature of 50° C. using an injection molding machine “J55ELII” (made by Japan Steel Works, Ltd.) so that a V notch of 2 mm depth was made in the center of the test piece. The test piece was 80 mm in length, 10 mm in width, and 4.0 mm in height. The number of molding shots was 100 consecutive shots after 300 shots were discarded. Charpy impact tests were then conducted in accordance with JIS-K7111, and the following criteria were used to evaluate the results.

“Double circle”: 8 kJ/m² or more.

“Circle”: 6 kJ/m² or more and less than 8 kJ/m².

“Triangle”: 4 kJ/m² or more and less than 6 kJ/m².

“Cross mark”: less than 4 kJ/m².

Ratings of “Double circle”, “Circle”, and “Triangle” indicate that there is no problem in practical use, and they are considered acceptable.

(Evaluation 2: Flame-Retardancy)

The obtained pellets of resin compositions 1 to 40 were dried at 80° C. for 4 hours, and then molded using the J55ELII injection molding machine (made by Japan Steel Works, Ltd.) at a cylinder temperature of 200° C. (240° C. only for resin composition 37) and mold temperature of 50° C. to obtain strip-type test pieces of 125 mm long, 13 mm wide and 1.6 mm thick. Test specimens were obtained.

The test specimens were then humidified for 48 hours in a thermostatic chamber at 23° C. and 50% humidity, and tested for flame-retardancy in accordance with the UL94 test (combustion test for plastic materials for equipment parts) established by Underwriters Laboratories (UL) of the United States of America. The test was conducted using the UL94V test method to confirm the ordinal order of flame-retardancy, and evaluation was made according to the following criteria.

“Double circle”: V-0

“Circle”: V-1

“Triangle” V-2

“Cross mark”: Non-standard

Ratings of “Double circle”, “Circle” and “Triangle” meet the UL94HB acceptance criteria and they are considered acceptable because there is no problem in practical use.

The composition and evaluation results of resin compositions 1 to 40 are shown in Tables I and II.

The symbol “-” indicates that it is not contained or cannot be measured, and “CMC” stands for carboxymethyl cellulose.

TABLE I

| | Composition | | | | | | | | |
|---|---|---|---|---|---|---|---|---|---|
| | | | Acidic polysaccharide | | | | | | |
| | Thermoplastic | | | | Number | | | | |
| | resin | | | | of acidic | | Compatibilizer | | |
| | | Content | | | functional | Content | | Acid value | Content |
| *1 | Type | [mass %] | Type | | group | [mass %] | Type | [mg/KOH] | [mass %] |
| 1 | PS | 73.0 | A12 | Alginic acid | 1.00 | 25.0 | SMA1 | 285 | 2.0 |
| 2 | PS | 73.0 | A1 | Calcium alginate | 1.00 | 25.0 | SMA1 | 285 | 2.0 |
| 3 | PS | 73.0 | A2 | Carrageenan | 0.50 | 25.0 | SMA1 | 285 | 2.0 |
| 4 | PS | 73.0 | A10 | Pectin | 0.40 | 25.0 | SMA1 | 285 | 2.0 |
| 5 | PS | 73.0 | A3 | Xanthan gum | 0.40 | 25.0 | SMA1 | 285 | 2.0 |
| 6 | PS | 73.0 | A11 | Gellan gum | 0.25 | 25.0 | SMAI | 285 | 2.0 |
| 7 | PS | 73.0 | A4 | Sodium alginate | 1.00 | 25.0 | SMA1 | 285 | 2.0 |
| 8 | PS | 73.0 | A9 | Barium alginate | 1.00 | 25.0 | SMA1 | 285 | 2.0 |
| 9 | PS | 73.0 | A13 | CMC | 0.10 | 25.0 | SMA1 | 285 | 2.0 |
| 10 | PS | 73.0 | A6 | CMC | 0.20 | 25.0 | SMA1 | 285 | 2.0 |
| 11 | PS | 73.0 | A7 | CMC | 0.61 | 25.0 | SMA1 | 285 | 2.0 |
| 12 | PS | 73.0 | A5 | CMC | 1.40 | 25.0 | SMA1 | 285 | 2.0 |
| 13 | PS | 73.0 | A8 | CMC | 1.70 | 25.0 | SMA1 | 285 | 2.0 |
| 14 | PS | 73.0 | A14 | CMC | 1.20 | 25.0 | SMA1 | 285 | 2.0 |
| 15 | PS | 96.0 | AI | Calcium alginate | 1.00 | 2.0 | SMA1 | 285 | 2.0 |
| 16 | PS | 93.0 | A1 | Calcium alginate | 1.00 | 5.0 | SMA1 | 285 | 2.0 |
| 17 | PS | 83.0 | A1 | Calcium alginate | 1.00 | 15.0 | SMA1 | 285 | 2.0 |
| 18 | PS | 63.0 | At | Calcium alginate | 1.00 | 35.0 | SMA1 | 285 | 2.0 |
| 19 | PS | 58.0 | A1 | Calcium alginate | 1.00 | 40.0 | SMA1 | 285 | 2.0 |
| 20 | PS | 48.0 | A1 | Calcium alginate | 1.00 | 50.0 | SMA1 | 285 | 2.0 |

| Resin | Processing | Evaluation | | |
|---|---|---|---|---|
| composition | temperature | Impact | Flame- | |
| No. | [° C.] | resistance | retardancy | Remarks |
| 1 | 200 | ◯ | Δ | Example |
| 2 | 200 | ⊚ | ◯ | Example |
| 3 | 200 | ◯ | Δ | Example |
| 4 | 200 | Δ | Δ | Example |
| 5 | 200 | ◯ | Δ | Example |
| 6 | 200 | Δ | Δ | Example |
| 7 | 200 | ◯ | ◯ | Example |
| 8 | 200 | ⊚ | ◯ | Example |
| 9 | 200 | Δ | Δ | Example |
| 10 | 200 | ⊚ | Δ | Example |
| 11 | 200 | ⊚ | ◯ | Example |
| 12 | 200 | ◯ | ◯ | Example |
| 13 | 200 | Δ | ◯ | Example |
| 14 | 200 | ⊚ | ◯ | Example |
| 15 | 200 | ◯ | Δ | Example |
| 16 | 200 | ⊚ | Δ | Example |
| 17 | 200 | ⊚ | ◯ | Example |
| 18 | 200 | ◯ | ◯ | Example |
| 19 | 200 | Δ | ⊚ | Example |
| 20 | 200 | Δ | ◯ | Example |

*1 Resin composition No.

TABLE II

| | Composition | | | | | | | | |
|---|---|---|---|---|---|---|---|---|---|
| | | | Acidic polysaccharide | | | | | | |
| | Thermoplastic | | | | Number | | | | |
| | resin | | | | of acidic | | Compatibilizer | | |
| | | Content | | | functional | Content | | Acid value | Content |
| *1 | Type | [mass %] | Type | | group | [mass %] | Type | [mg/KOH] | [mass %] |
| 21 | PS | 74.9 | A1 | Calcium alginate | 1.00 | 25.0 | SMA1 | 285 | 0.1 |
| 22 | PS | 74.5 | A1 | Calcium alginate | 1.00 | 25.0 | SMA1 | 285 | 0.5 |
| 23 | PS | 74.0 | A1 | Calcium alginate | 1.00 | 25.0 | SMA1 | 285 | 1.0 |
| 24 | PS | 70.0 | A1 | Calcium alginate | 1.00 | 25.0 | SMA1 | 285 | 5.0 |
| 25 | PS | 65.0 | A1 | Calcium alginate | 1.00 | 25.0 | SMA1 | 285 | 10.0 |
| 26 | PS | 55.0 | A1 | Calcium alginate | 1.00 | 25.0 | SMAI | 285 | 20.0 |
| 27 | PS | 50.0 | A1 | Calcium alginate | 1.00 | 25.0 | SMA1 | 285 | 25.0 |
| 28 | PS | 73.0 | A1 | Calcium alginate | 1.00 | 25.0 | MA-g-PP1 | 23 | 2.0 |
| 29 | PS | 73.0 | A1 | Calcium alginate | 1.00 | 25.0 | SMA2 | 120 | 2.0 |
| 30 | PS | 73.0 | A1 | Calcium alginate | 1.00 | 25.0 | SMA3 | 475 | 2.0 |
| 31 | PS | 73.0 | A1 | Calcium alginate | 1.00 | 25.0 | SMA1 | 285 | 2.0 |
| 32 | PS | 73.0 | A1 | Calcium alginate | 1.00 | 25.0 | SMA1 | 285 | 2.0 |
| 33 | PS | 73.0 | A1 | Calcium alginate | 1.00 | 25.0 | EGMA-g-PS | — | 2.0 |
| 34 | PS | 73.0 | A1 | Calcium alginate | 1.00 | 25.0 | MA-g-SEBS1 | 2 | 2.0 |
| 35 | PS | 73.0 | A1 | Calcium alginate | 1.00 | 25.0 | MA-g-SEBS2 | 10 | 2.0 |
| 36 | PS/ | 73.0 | A1 | Calcium alginate | 1.00 | 25.0 | MA-g-PP2 | 52 | 2.0 |
| | ABS | | | | | | | | |
| 37 | PS | 73.0 | A1 | Calcium alginate | 1.00 | 25.0 | SMA1 | 285 | 2.0 |
| 38 | PS | 75.0 | C1 | Cellulose | 0.00 | 25.0 | — | — | — |
| 39 | PS | 73.0 | C1 | Cellulose | 0.00 | 25.0 | SMA1 | 285 | 2.0 |
| 40 | PS | 75.0 | A1 | Calcium alginate | 1.00 | 25.0 | — | — | — |

| Resin | Processing | Evaluation | | |
|---|---|---|---|---|
| composition | temperature | Impact | Flame- | |
| No. | [° C.] | resistance | retardancy | Remarks |
| 21 | 200 | ◯ | Δ | Example |
| 22 | 200 | ◯ | ◯ | Example |
| 23 | 200 | ⊚ | ◯ | Example |
| 24 | 200 | ⊚ | ◯ | Example |
| 25 | 200 | ⊚ | ◯ | Example |
| 26 | 200 | ◯ | ◯ | Example |
| 27 | 200 | Δ | ◯ | Example |
| 28 | 200 | ◯ | Δ | Example |
| 29 | 200 | ⊚ | ◯ | Example |
| 30 | 200 | ⊚ | ◯ | Example |
| 31 | 200 | ⊚ | ◯ | Example |
| 32 | 200 | ◯ | ◯ | Example |
| 33 | 200 | ◯ | ◯ | Example |
| 34 | 200 | ◯ | Δ | Example |
| 35 | 200 | ◯ | Δ | Example |
| 36 | 200 | ◯ | ◯ | Example |
| 37 | 240 | ◯ | ◯ | Example |
| 38 | 200 | X | X | Comparative |
| | | | | Example |
| 39 | 200 | Δ | X | Comparative |
| | | | | Example |
| 40 | 200 | Δ | Δ | Comparative |
| | | | | Example |

*1 Resin composition No.

The above evaluation results show that the flame-retardant resin compositions of the present invention have improved flame-retardancy and impact resistance when an acidic polysaccharide and a compatibilizer are included.

Although the reference example (resin composition 40) containing only an acidic polysaccharide also has sufficient flame-retardancy and impact resistance for practical use, comparison with resin compositions 2, 28 to 30 and 33 to 36 shows that the flame-retardancy and impact resistance are further improved by the inclusion of a compatibilizer.

The comparison of resin compositions 1 to 14 and 39 shows that the inclusion of an acidic polysaccharide improves flame-retardancy and impact resistance.

Comparison of resin compositions 2, 7, and 8 shows that when the salt of the acidic functional group is more than bivalent, the impact resistance is improved.

Comparison of resin compositions 9 to 14 shows that the number of acidic functional groups (total number of the acidic functional group and the salt of the acidic functional group per monosaccharide unit) in acidic polysaccharides in the range of 0.20 to 1.40, especially in the range of 0.60 to 1.20, improves flame-retardancy and impact resistance.

Comparison of resin compositions 15, 16, 19 and 20 shows that the flame-retardancy and impact resistance are improved when the content of acidic polysaccharide to the total mass of the resin composition is in the range of 5.0 to 40.0 mass %.

Comparison of resin compositions 21, 22, 26 and 27 shows that the flame-retardancy and impact resistance are improved when the content of compatibilizer to the total mass of the resin composition is in the range of 0.5 to 20.0 mass %.

From the resin compositions 1 to 8, it can be seen that the acidic polysaccharides have sufficient flame-retardancy and impact resistance for practical use when they contain at least alginic acid, alginate, carrageenan, pectin, xanthan gum, or gellan gum. In particular, when the alginate is calcium alginate, the flame-retardancy and impact resistance are improved.

The comparison of resin compositions 2, 28 to 30 and 33 to 36 shows that the impact resistance is improved when the compatibilizer is a copolymer with structural units derived from maleic acid.

Comparison of resin compositions 28, 30, and 34 to 36 shows that when the acid value of copolymers with structural units derived from maleic acid is in the range of 50 to 500 mg/KOH, and especially in the range of 100 to 500 mg/KOH, flame-retardancy and impact resistance are improved.

Comparison of resin compositions 2, 28 to 30, and 33 to 36 shows that when the copolymer having structural units derived from maleic acid is a styrene/maleic anhydride copolymer, flame-retardancy and impact resistance are improved.

From the comparison of resin compositions 2, 31, 32, and 37, it can be seen that the flame-retardancy and impact resistance are improved when the softening point of the thermoplastic resin is 200° C. or lower. It can also be seen that the flame-retardancy and impact resistance are improved when the thermoplastic resin is a polystyrene-based resin.

Although embodiments of the present invention have been described and illustrated in detail, the disclosed embodiments are made for purposes of illustration and example only and not limitation. The scope of the present invention should be interpreted by terms of the appended claims.

### REFERENCE SIGNS LIST

10: Large-size copying machine
G1 to G9: Exterior component

1. A flame-retardant resin composition containing at least a thermoplastic resin and a polysaccharide; wherein the polysaccharide is an acidic polysaccharide; and the flame-retardant resin composition further contains a compatibilizer.

2. The flame-retardant resin composition according to claim 1, wherein a sugar backbone in the acidic polysaccharide has at least an acidic functional group or a salt of an acidic functional group.

3. The flame-retardant resin composition according to claim 2, wherein the salt of an acidic functional group is a salt of divalent or higher.

4. The flame-retardant resin composition according to claim 2, wherein a total number of the acidic functional group and the salt of the acidic functional group per monosaccharide unit in the acidic polysaccharide is in the range of 0.20 to 1.40.

5. The flame-retardant resin composition according to claim 4, wherein the total number of the acidic functional group and the salt of the acidic functional group per monosaccharide unit in the acidic polysaccharide is in the range of 0.60 to 1.20.

6. The flame-retardant resin composition according to claim 1, wherein a content of the acidic polysaccharide to the total mass of the flame-retardant resin composition is in the range of 5.0 to 40.0 mass %.

7. The flame-retardant resin composition according to claim 1, wherein a content of the compatibilizer to the total mass of the flame retardant resin composition is in the range of 0.5 to 20.0 mass %.

8. The flame-retardant resin composition according to claim 2, wherein the acidic functional group is a carboxy group or a sulfo group.

9. The flame-retardant resin composition according to claim 1, wherein the acidic polysaccharide include at least one of alginic acid, alginate, carrageenan, pectin, xanthan gum or gellan gum.

10. The flame-retardant resin composition according to claim 9, wherein the alginate is calcium alginate.

11. The flame-retardant resin composition according to claim 1, wherein the compatibilizer is a copolymer having a structural unit derived from maleic acid.

12. The flame-retardant resin composition according to claim 11, wherein an acid value of the copolymer having a structural unit derived from maleic acid is in the range of 50 to 500 mg/KOH.

13. The flame-retardant resin composition according to claim 12, wherein an acid value of the copolymer having a structural unit derived from maleic acid is in the range of 100 to 500 mg/KOH.

14. The flame-retardant resin composition according to claim 11, wherein the copolymer having structural unit derived from maleic acid is a styrene/maleic anhydride copolymer.

15. The flame-retardant resin composition according to claim 1, wherein a softening point of the thermoplastic resin is 200° C. or less.

16. The flame-retardant resin composition according to claim 1, wherein the thermoplastic resin is a polystyrene resin.

17. A flame-retardant resin molded product formed using the flame-retardant resin composition according to claim 1.

18. A flame-retardant resin housing including the flame-retardant resin molded product according to claim 17.

19. An electronic device provided with the flame-retardant resin molded product according to claim 17.
